(19) United States
(12) Patent Application Publication
(10) Pub. No.: US 2015/0120708 A1
(43) Pub. Date: Apr. 30, 2015

(54) Information aggregation, classification and display method and system

(71) Applicant: TENCENT TECHNOLOGY (SHENZHEN) COMPANY LIMITED, Shenzhen (CN)

(72) Inventor: Feng Kang, Shenzhen (CN)

(21) Appl. No.: 14/584,221

(22) Filed: Dec. 29, 2014

Related U.S. Application Data
(63) Continuation of application No. PCT/CN2013/081802, filed on Aug. 19, 2013.

(30) Foreign Application Priority Data
Aug. 22, 2012 (CN) 201210300750.1

(51) Int. Cl. G06F 17/30

(52) U.S. Cl. CPC G06F 17/30598; G06F 17/30554
USPC 707/722; 707/739

(57) ABSTRACT

Described are a method and system for aggregating, categorizing, and displaying information. With the method, information is acquired from an information-exchanging-sharing platform, and a content keyword of the information is extracted; the information is aggregated and categorized according to the content keyword; and the information is displayed according to each category. In the system, a keyword extracting unit is configured for acquiring information from an information-exchanging-sharing platform, and extracting a content keyword of the information; an aggregating-categorizing unit is configured for aggregating and categorizing the information according to the content keyword; and a displaying unit is configured for displaying the information according to each category. With what described, it is possible to display aggregated and categorized information, facilitating information sharing and exchanging as well as reducing complexity in user operation.

### TECHNICAL FIELD

The disclosure relates to aggregation technology, in particular to a method and system for aggregating, categorizing, and displaying information.

### BACKGROUND

With popularization of internet, information sharing and exchanging has become an indispensable part of daily life and work, in particular in interaction in some social networks and media. At present, information used in interaction among users is often displayed in form of single pieces of information, that is, in nature, information is ultimately displayed piece by piece; whenever a user releases a piece of information, the piece of information is displayed, thereby leading to randomness and fragmented nature of displayed information. Meanwhile, the advent of internet brings about massive amount of information. Consequently, overwhelmingly massive amount of information is displayed randomly in a fragmented manner in social networks and media. This is very disadvantageous for information sharing and exchanging, as it is barely possible for a user to directly find various kinds of useful information the user cares about from massive amount of information. Instead, source data first has to be acquired from an information-exchanging-sharing platform by reading massive amount of information and constantly refreshing the information, then the user has to personally categorize and integrate the acquired source data.

To sum up, a problem with existing technology lies in that: as in nature, information is ultimately displayed piece by piece, massive amount of information is displayed randomly and in a fragmented manner, which is disadvantageous for information sharing and exchanging, such that a user has to categorize and integrate information, leading to complexity in user operation.

### SUMMARY

In view of this, embodiments of the disclosure provide a method and system for aggregating, categorizing, and displaying information, capable of displaying aggregated and categorized information, facilitating information sharing and exchanging as well as reducing complexity in user operation.

A technology solution of an embodiment of the disclosure is implemented as follows.

An embodiment of the disclosure provides a method for aggregating, categorizing, and displaying information, including steps of:

acquiring information from an information-exchanging-sharing platform, and extracting a content keyword of the information; aggregating and categorizing the information according to the content keyword; and displaying the information according to each category.

An embodiment of the disclosure provides a system for aggregating, categorizing, and displaying information, including a keyword extracting unit, an aggregating-categorizing unit, and a displaying unit, wherein

the keyword extracting unit is configured for acquiring information from an information-exchanging-sharing platform, and extracting a content keyword of the information;

the aggregating-categorizing unit is configured for aggregating and categorizing the information according to the content keyword; and

the displaying unit is configured for displaying the information according to each category.

With an embodiment of the disclosure, information is acquired from an information-exchanging-sharing platform, and a content keyword of the information is extracted; the information is aggregated and categorized according to the content keyword; and the information is displayed according to each category.

With existing technology, information is not categorized, but just displayed in form of single pieces of information. With an embodiment of the disclosure, information is aggregated and categorized according to a content keyword, and in the end, an aggregated-and-categorized result is output and displayed, where the aggregation, categorization and displaying are automatic operations that do not require a user to obtain source data in form of single pieces of information and then perform manual categorization and integration in person, thus facilitating information sharing and exchanging as well as reducing complexity in user operation.

### BRIEF DESCRIPTION OF THE DRAWINGS

FIG. 1 is a flowchart of a method according to an embodiment of the disclosure;

FIG. 2 is a schematic diagram of a structure of a system according to an embodiment of the disclosure.

### DETAILED DESCRIPTION

In an embodiment of the disclosure, information is acquired from an information-exchanging-sharing platform, and a content keyword of the information is extracted; the information is aggregated and categorized according to the content keyword; and the information is displayed according to each category.

Implementation of a technology solution is further elaborated below with reference to the drawings.

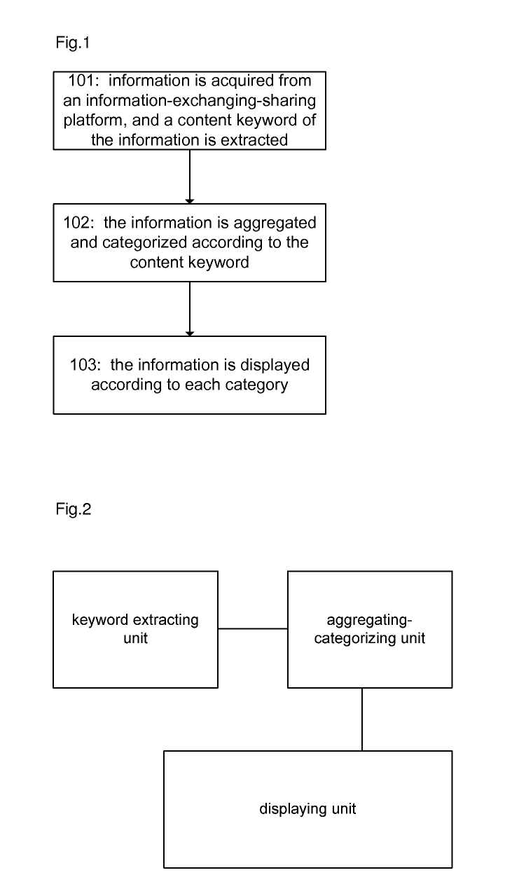

A method for aggregating, categorizing, and displaying information according to an embodiment of the disclosure, as shown in FIG. 1, includes steps as follows.

In step 101, information is acquired from an information-exchanging-sharing platform, and a content keyword of the information is extracted.

Here, step 101 may specifically include: searching the information-exchanging-sharing platform for multiple pieces of information, and taking identical content, similar content, frequently-occurring content, or content at a specified location (such as inside quotation marks, brackets or parentheses, double brackets) in the multiple pieces of information as the content keyword.

In step 102, the information is aggregated and categorized according to the content keyword.

Here, step 102 may specifically include: taking the content keyword as a category to which information corresponding to the content keyword belongs, and aggregating the information corresponding to the content keyword in the same category as a subset of the category.

In step 103, the information is displayed according to each category.

Here, step 103 may specifically include three specific implementations, namely: displaying the information according to a title of information aggregated in each category, a degree of popularity of information aggregated in each category, or a feedback on information aggregated in each category, as illustrated below respectively.

In implementation 1, the step of displaying the information according to a title of information aggregated in each category may specifically include:

searching all information in each category according to a configured candidate set including a rule for matching one item or a combination of at least one item of a wildcard, an identifier, text, a letter, a character as specified, a phrase within specified punctuations (such as quotation marks, brackets or parentheses, double brackets or the like), and content in a first information section or content in a last information section; and

when content matching the one item or the combination of at least one item in the candidate set is found in the searched information, comparing the found content with the content keyword corresponding to the category of the searched information, selecting content in the content keyword that repeats frequently in the found content as the title of the category, and displaying the information according to the title of each category.

In implementation 2, the step of displaying the information according to a degree of popularity of information aggregated in each category may specifically include way 1 and/or way 2 as follows.

In way 1, all information in each category is searched; a frequency of occurrence with which a piece of information in each category occurs, and then a total frequency of occurrence for each category, are acquired; the total frequency of occurrence for each category is taken as the degree of popularity of information aggregated in each category; and the information is displayed according to the degree of popularity of information aggregated in each category. For example, if a frequency of occurrence is a number of times a piece of information is forwarded, and a piece of information in the current category is forwarded for a total number of times of 10, the piece of information is then marked as “forwarded 10 times” and then displayed. For another example, if in a category there are 10 related pieces of information, each related piece being forwarded 10 times, then a total forwarding degree of popularity of the category is 100. The degree of popularity of the category will be marked as 100.

In way 2, all information in each category is searched; a total amount of information in each category is acquired as the degree of popularity of information aggregated in each category; and the information is displayed according to the degree of popularity of information aggregated in each category. For example, a category with totally 100 pieces of information is marked with “including 100 pieces of information”, and then information in the category is displayed.

Thus, by a mark, a user may visually know which information or which category is more cared about, so as to perform an operation more easily.

In implementation 3, the step of displaying the information according to a feedback on information aggregated in each category may specifically include:

searching for feedback information of all information in a category, aggregating and categorizing the found feedback information into the category, and displaying information in the category.

As described before, in each category, there will be multiple pieces of information of the same type that may exist as a subset of the category; meanwhile there will also be a lot of feedback information directed at each piece of information, i.e., views upon a subject or content of each piece of information. Then, for optimal information resource integration, feedback information directed at a piece of information may also be aggregated to correspond the piece of information, that is, an information set formed by aggregating feedback information of a piece of information is a subset of the piece of information. Here, a detailed category and degree of popularity of the information set formed by aggregating feedback information may be further obtained likewise, which is not elaborated here. Note that feedback information may be directed at a piece of information, or may be directed at a type of information, such as feedback information directed at each category, which is not elaborated here.

A system for aggregating, categorizing, and displaying information according to an embodiment of the disclosure, as shown in FIG. 2, includes a keyword extracting unit, an aggregating-categorizing unit, and a displaying unit. The keyword extracting unit is configured for acquiring information from an information-exchanging-sharing platform, and extracting a content keyword of the information. The aggregating-categorizing unit is configured for aggregating and categorizing the information according to the content keyword. The displaying unit is configured for displaying the information according to each category.

Here, the keyword extracting unit may be further configured for searching the information-exchanging-sharing platform for multiple pieces of information, and extracting identical content, similar content, or frequently-occurring content in the multiple pieces of information as the content keyword.

Here, the aggregating-categorizing unit may be further configured for taking the content keyword as a category to which information corresponding to the content keyword belongs, and aggregating the information corresponding to the content keyword in the same category as a subset of the category.

Here, the displaying unit may be further configured for displaying the information according to a title of information aggregated in each category, a degree of popularity of information aggregated in each category, or a feedback on information aggregated in each category.

An example is described below, where the information-exchanging-sharing platform is specifically a micro-blog platform but not limited thereto.

A flow of a method based on micro-blog platform may include steps as follows.

In step 201, news data are obtained from a micro-blog platform, and a content keyword in the news data is extracted, and the news data are automatically aggregated and categorized according to the content keyword. Moreover, a category will be constantly updated as new news data are constantly produced and updated.

In step 202, after the news data are automatically aggregated and categorized, similar news data are automatically aggregated into a category of news subjects.

After step 202 is executed, one of optional steps 203a-203c as follows may be executed.

In step 203a, a sentence may be selected, from all news data in each category according to an algorithm, as the title of a news subject to be displayed.

Here, in multiple pieces of news data within a category of news subjects, the algorithm for extracting the title for example may be: extracting, from each piece of micro-blog, a first sentence, or an expression contained in two special symbols such as double brackets “[]”, as a candidate set that may serve as the title. Cosine similarities between keywords extracted from each piece of expression in the candidate set and a central node of the category is calculated. A keyword with the highest similarity is taken as the title of the category.

In step 203b, a degree of popularity of each piece of news data in the category is calculated, and the degree of popularity of each piece of news data is aggregated as the degree of popularity of the news subject to be displayed.

Here, an algorithm for calculating a degree of popularity for example may be: after aggregation and categorization, there are 30 pieces of micro-blog in a category A, and each of the 30 pieces of micro-blog is forwarded 50 times. The degree of popularity of the news subject is then 30×50=1500. If there are 100 pieces of micro-blog in another category B, where each piece is forwarded 20 times, however. The degree of popularity of the category B is then 100×20=2000. Thus, when finally sorted and laid out, the category B will rank first on top of the category A, such that a user may see the category B first.

In step 203c, a user comment on each piece of news data in an aggregated category may serve as a user comment on the news subject to be displayed.

Here, each piece of news data may have a user comment per se, after news data are aggregated, such a user comment may be also aggregated and displayed as a user comment on a corresponding news subject, instead of just as that on a single piece of news.

In step 204, a category may be sorted according to a degree of popularity of the category, instead of that of a single piece of news, and a sorted result, as well as a title of each news subject, news data in the category of the subject, and any user comment on the subject (instead of any user comment on a single piece of news), may be output.

Here, instead of sorting and displaying according to the degree of popularity of a single piece of news, with a new way of sorting and displaying, degrees of popularity of related news of the same subject from different sources may be collected as the degree of popularity of the news subject.

It may be seen that when applied to a micro-blog platform, such a solution as in an embodiment of the disclosure is of notable advantages compared with existing technology. In existing technology, there are news data released by a lot of user accounts in a micro-blog platform. All such news data are displayed in form of single pieces of news data. With a common way of sorting and displaying, news is sorted piece by piece according to a nature of a single piece of news (rather than a nature of a category of news data), such as according to a number of times a single piece of news is forwarded, or according to a time sequence a single piece of news is released. In fact, news data of the same news subject may be released by different user accounts. For example, in a case of a news event of “exposure of industrial gelatin”, news relevant to the category of the subject is reported by multiple news media such as The Economic Observer and National Business Daily. In addition, what shown by each piece of news data may be different aspects of the same news subject. With existing technology, a user can only see single pieces of news displayed according to, for example, a degree of popularity or a time of news on “industrial gelatin” reported by the news medium National Business Daily. With an embodiment of the disclosure, sorting and displaying are performed according to a category of subjects, i.e., according to a title, a degree of popularity, a view and the like of a news subject. Thus, taking the same example of “industrial gelatin”, displaying may be performed according to the news subject “industrial gelatin”, namely, any news relevant to “industrial gelatin” in a micro-blog platform is aggregated into a category “industrial gelatin”, where sorting and displaying are performed with the category of the news subject, thereby facilitating information exchanging and sharing.

To sum up, an aspect in addition to the mentioned prominent advantages with an embodiment of the disclosure should be noted. With existing technology, information exchanging and sharing are implemented by logging, by a user, into a user account through a client device, entering an information-exchanging-sharing platform, releasing information, forwarding information, or posting a piece of replying information. Such communication between a client device (not limited to a mobile phone, a PAD, a personal palm computer and a digital electronic product, a desktop computer) and an information-exchanging-sharing platform (not limited to a micro-blog platform) requires to acquire data and feedback by constant data reading and refreshing. With such a way of acquiring and feeding back data by back-and-forth accessing, if way of displaying by single pieces of information without categorization in existing technology is still adopted, the cost for a user to acquire effective data is inevitably increased, as there is too much information to directly get desired effective data, leading to complexity in user operation. On the other hand, there are much communication between a client device and an information-exchanging-sharing platform, while just a few effective data can be obtained via accessing, such that not only there is a low efficiency in accessing, but also the more communication between a client device and an information-exchanging-sharing platform, the more requests /responses there are, which will also lead to network resource and bandwidth occupation. With an embodiment of the disclosure, as information is categorized and then displayed, and there will be various cues for sorting and displaying, such as a degree of popularity, a title, feedback, which will allow a user to obtain more effective data within a shortest period of time, as with an embodiment of the disclosure, before being displayed, information has been categorized beforehand on an information-exchanging-sharing platform, such that a user may obtain effective data directly, instead of unprocessed source data. Consequently, complexity in user operation is reduced, efficiency in accessing is increased, and the number of times of communication is lowered, thereby saving network resource and bandwidth overhead.

When implemented in form of a software functional module and sold or used as an independent product, an integrated module of an embodiment of the present disclosure may also be stored in a non-transitory computer-readable storage medium. Based on such an understanding, the essential part or a part contributing to prior art of the technical solution of an embodiment of the present disclosure may appear in form of a software product, which software product is stored in storage media, and includes a number of instructions for allowing a computer equipment (such as a personal computer, a server, a network equipment, or the like) to execute all or part of the methods in various embodiments of the present disclosure. The storage media include various media that can store program codes such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the present disclosure further provides a non-transitory computer storage medium storing a computer program for executing a method for aggregating, categorizing, and displaying information according to an embodiment of the present disclosure.

What described are merely embodiments of the disclosure, and are not intended to limit the scope of protection of the disclosure.

1. A method for aggregating, categorizing, and displaying information, comprising:
acquiring information from an information-exchanging-sharing platform;
extracting a content keyword of the information;
aggregating and categorizing the information according to the content keyword; and
displaying the information according to each category.

2. The method according to claim 1, wherein the extracting a content to keyword of the information comprises:
searching the information-exchanging-sharing platform for multiple pieces of information, and taking identical content, similar content, frequently-occurring content, or content at a specified location in the multiple pieces of information as the content keyword.

3. The method according to claim 1, wherein the aggregating and categorizing the information according to the content keyword comprises:
taking the content keyword as a category to which information corresponding to the content keyword belongs, and aggregating the information corresponding to the content keyword in the same category as a subset of the category.

4. The method according to claim 3, wherein the displaying the information according to each category comprises:
displaying the information according to a title of information aggregated in each category, a degree of popularity of information aggregated in each category, or a feedback on information aggregated in each category.

5. The method according to claim 4, wherein the displaying the information according to a title of information aggregated in each category comprises:
searching all information in each category according to a configured candidate set comprising a rule for matching one item or a combination of at least one item of a wildcard, an identifier, text, a letter, a character as specified, a phrase within specified punctuations, and content in a first information section or content in a last information section; and
when content matching the one item or the combination of at least one item in the candidate set is found in the searched information, comparing the found content with the content keyword corresponding to the category of the searched information, selecting content in the content keyword that repeats frequently in the found content as the title of the category, and displaying the information according to the title of each category.

6. The method according to claim 4, wherein the displaying the information according to a degree of popularity of information aggregated in each category comprises:
searching all information in each category; acquiring a frequency of occurrence with which a piece of information in each category occurs and then acquiring a total frequency of occurrence for each category, and/or acquiring a total amount of information in each category; taking the total frequency of occurrence for each category and/or the total amount of information in each category as the degree of popularity of information aggregated in each category; and displaying the information according to the degree of popularity of information aggregated in each category.

7. The method according to claim 4, wherein the displaying the information according to a feedback on information aggregated in each category comprises:
searching for feedback information of all information in a category, aggregating and categorizing the found feedback information into the category, and displaying information in the category.

8. A system for aggregating, categorizing, and displaying information, comprising:
a keyword extracting unit, configured to acquire information from an information-exchanging-sharing platform, and extract a content keyword of the information;
an aggregating-categorizing unit, configured to aggregate and categorize the information according to the content keyword; and
a displaying unit, configured to display the information according to each category.

9. The system according to claim 8, wherein the keyword extracting unit is further configured to search the information-exchanging-sharing platform for multiple pieces of information, and extract identical content, similar content, or frequently-occurring content in the multiple pieces of information as the content keyword.

10. The system according to claim 8, wherein the aggregating-categorizing unit is further configured to take the content keyword as a category to which information corresponding to the content keyword belongs, and aggregate the information corresponding to the content keyword in the same category as a subset of the category.

11. The system according to claim 10, wherein the displaying unit is further configured to display the information according to a title of information aggregated in each category, a degree of popularity of information aggregated in each category, or a feedback on information aggregated in each category.

12. The system according to claim 9, wherein the aggregating-categorizing unit is further configured to take the content keyword as a category to which information corresponding to the content keyword belongs, and aggregate the information corresponding to the content keyword in the same category as a subset of the category.

13. The system according to claim 12, wherein the displaying unit is further configured to display the information according to a title of information aggregated in each category, a degree of popularity of information aggregated in each category, or a feedback on information aggregated in each category.

14. The method according to claim 2, wherein the aggregating and categorizing the information according to the content keyword comprises:
taking the content keyword as a category to which information corresponding to the content keyword belongs, and aggregating the information corresponding to the content keyword in the same category as a subset of the category.

15. The method according to claim 14, wherein the displaying the information according to each category comprises:
displaying the information according to a title of information aggregated in each category, a degree of popularity of information aggregated in each category, or a feedback on information aggregated in each category.

16. The method according to claim 15, wherein the displaying the information according to a title of information aggregated in each category comprises:
searching all information in each category according to a configured candidate set comprising a rule for matching one item or a combination of at least one item of a wildcard, an identifier, text, a letter, a character as specified, a phrase within specified punctuations, and content in a first information section or content in a last information section; and
when content matching the one item or the combination of at least one item in the candidate set is found in the searched information, comparing the found content with the content keyword corresponding to the category of the searched information, selecting content in the content keyword that repeats frequently in the found content as the title of the category, and displaying the information according to the title of each category.

17. The method according to claim 15, wherein the displaying the information according to a degree of popularity of information aggregated in each category comprises:
searching all information in each category; acquiring a frequency of occurrence with which a piece of information in each category occurs and then acquiring a total frequency of occurrence for each category, and/or acquiring a total amount of information in each category; taking the total frequency of occurrence for each category and/or the total amount of information in each category as the degree of popularity of information aggregated in each category; and displaying the information according to the degree of popularity of information aggregated in each category.

18. The method according to claim 15, wherein the displaying the information according to a feedback on information aggregated in each category comprises:
searching for feedback information of all information in a category, aggregating and categorizing the found feedback information into the category, and displaying information in the category.
